(19) United States
(12) Patent Application Publication
(10) Pub. No.: US 2012/0093340 A1
(43) Pub. Date: Apr. 19, 2012

(54) VARIABLE DIRECTIONAL MICROPHONE UNIT AND VARIABLE DIRECTIONAL MICROPHONE

(76) Inventor: Haruhito Shimura, Tokyo (JP)

(21) Appl. No.: 13/275,445

(22) Filed: Oct. 18, 2011

(30) Foreign Application Priority Data
Oct. 19, 2010 (JP) 2010-234138

(51) Int. Cl. H04R 3/00

(52) U.S. Cl. 381/92

(57) ABSTRACT

A variable directional microphone unit includes, a pair of microphone elements disposed back to back, output signal systems of the microphone elements connected to a hot-side terminal and a cold-side terminal of a balanced output respectively, an inverting amplifier connected to one output signal system of the microphone elements, an input resistance and a feedback resistance of the inverting amplifier at least any one of which is divided, and a switching device switching a signal retrieving point by arbitrarily selecting each divide of at least one of the input resistance or the feedback resistance. The switching device switches one output of the balanced output to enable directivity of the balanced output signal to vary. A circuit for switching the directivity does not become a load or a noise source.

### BACKGROUND OF THE INVENTION

1. Field of the Invention

The present invention relates to a variable directional microphone unit and a variable directional microphone which switch directivity by switching an electric circuit. The low-noise variable directional microphone unit and variable directional microphone realize a wide to variable directivity expanding from bidirectionality to omnidirectionality with a simple circuit.

2. Related Background Art

A conventional variable directional microphone is known that includes a microphone unit providing two condenser microphone elements back to back (for example, see Japanese Unexamined Patent Application Publication No. H07-143595 and Japanese Unexamined Patent Application Publication No. 2008-067286). Each of the two microphone elements has a cardioid characteristic. The variable directivity is achieved by controlling each output of the two microphone elements or controlling each polarization voltage of the two microphone elements as described in Japanese Unexamined Patent Application Publication No. H07-143595. Microphone units, providing two condenser microphone elements back to back and being disclosed in Japanese Unexamined Patent Application Publication No.2008-118260 and Japanese Unexamined Patent Application Publication No. 2010-103637, are known.

FIG. 3 shows an example of directivities obtained by the microphone providing the two condenser microphone elements back to back. FIGS. 4 and 5 show examples of the conventional condenser microphone unit that obtain various directivities as shown in FIG. 3 by switching a circuit.

At the upper side of FIG. 3, a curved-solid line represents directivity of a front microphone element and a broken line represents directivity of a rear microphone element. In the above example of FIG. 3, the front microphone element keeps unidirectionality and switches an output and polarity of the rear microphone element. The lower side of FIG. 3 depicts directivity which the microphone unit obtains by switching the output and polarity of the rear microphone element. Example (iii) in the center represents unidirectionality obtained only by the front microphone element without being affected by the rear microphone element, that is, without any output from the rear microphone element.

Gradually increasing the output of the rear microphone element varies the directivity from unidirectionality to directivity represented by examples other than example (iii). Examples (i) and (ii) each represent a case where output polarity of the rear microphone element is negative. A maximum output of the rear microphone element obtains bidirectionality as shown in example (i) and a low output of the rear microphone element obtains hypercardioid directivity as shown in example (ii). Examples (iv) and (v) each represent a case where output polarity of the rear microphone element is positive. A maximum output of the rear microphone element obtains omnidirectionality as shown in the example (v) and a low output of the rear microphone element obtains wide-directionality as shown in the example (iv).

FIG. 4 illustrates an example of a circuit of a conventional variable directional condenser microphone capable of varying its directivity as shown in FIG. 3. In FIG. 4, the condenser microphone unit 50 includes a first microphone element 51 having a diaphragm 53 and a common fixed electrode 55, a second microphone element 52 having a diaphragm 54 and the common fixed electrode 55. Each of the diaphragms 53 and 54 faces the electrode 55 with a certain gap therebetween. Microphone elements 51 and 52 compose a pair of microphone elements. A predetermined polarization voltage is applied to the diaphragm 53 of the microphone element 51, which is one of the pair of microphone elements and then, polarization voltage applied to the diaphragm 54 of the microphone element 52 is switched to switch the directivity of the microphone unit 50.

In the example in FIG. 4, a DC power source at +60V and a DC power source at −60V are included, and voltage at +60V is constantly applied to the diaphragm 53 of the one microphone element 51. Voltages of the sources at +60V and −60V are respectively divided by voltage dividers 61, 62 and voltage dividers 63, 64 in two stages (e.g. −60V and 30V) so as to generate five-level voltages including voltage at 0V. The five-level voltages are selected by a switch 56 to be applied to the diaphragm 54 of the other microphone elements 52. Voltage at 0V is applied to the fixed electrode 55 (also called “back plate”) for both microphone elements.

When a switch 50 illustrated in FIG. 4 selects a contact 1, the first microphone element 51 has polarization voltage at +60V, whereas the second microphone element 52 has polarization voltage at −60V, thereby configuring a microphone unit with a bidirectional characteristic shown in FIG. 3 (i), that is, a directional characteristic obtained by subtracting output of the rear microphone element from output of the microphone element. When the switch selects a contact 2, the microphone element 52 has polarization voltage in the range of −60V to 0V (e.g. −30V), thereby configuring a microphone unit with a hypercardioid directional characteristic shown in FIG. 3 (ii). When the switch selects a contact 3, the microphone element 52 has polarization voltage at 0V, thereby configuring a microphone unit having a cardioid directional characteristic shown in FIG. 3 (iii), that is, a microphone unit outputting signals only from the microphone element on the front surface. When the switch selects a contact 4, the microphone element 52 has polarization voltage in the range of 0V to 60V (e.g. 30V), thereby configuring a microphone unit with a wide cardioid directional characteristic shown in FIG. 3 (iv). When the switch selects a contact 5, the microphone element 52 has polarization voltage at +60V, thereby configuring a microphone unit with an omnidirectional directivity, that is, a microphone unit with a directional characteristic obtained by adding the output from the microphone element at the front surface to an output of the microphone element at the back surface.

FIG. 5 illustrates another example of a circuit of a conventional variable directional condenser microphone unit capable of varying its directivity. In FIG. 5, reference numerals 10 and 20 represent microphone elements. In FIG. 5, the two condenser microphone elements 10 and 20 are depicted as if they are separately disposed. In fact, the two condenser microphone elements 10 and 20 are integrally assembled back to back having a fixed electrode therebetween or anteroposteriorly assembled having a fixed electrode in common. The microphone element 10 has a diaphragm 11 and the fixed electrode 12 facing diaphragm 11. A signal output from the microphone element 10 is output as a hot-side signal of a balanced output through an impedance converter 13 including an FET and a buffer amplifier 15. The microphone element 20 has a diaphragm 21 and a fixed electrode 22 facing the diaphragm 21. A signal output from the microphone element 20 is output as a cold-side signal of a balanced output through an impedance converter 23 including an FET and a buffer amplifier 25.

The microphone element 10 is a front element and the microphone element 20 is a back element. In the microphone element 20, the following directivity converting circuit including an inverting amplifier 24 is interposed between the impedance converter 23 and the buffer amplifier 25. An output of the impedance converter 23 is connected to a first contact of a switch having five switching contacts and to an inverting input terminal of the inverting amplifier 24 through an input resistance Rs. A noninverting input terminal of the inverting amplifier 24 is grounded. An output terminal of the inverting amplifier 24 is connected to the fifth contact of the switch and to the inverting input terminal through a feedback resistance Rf. A gain of the inverting amplifier 24 is determined by the ratio between the feedback resistance Rf and the input resistance Rs.

An attenuator in which resistances R1, R2, R3 and R4 are connected in series is connected between the output terminal of the impedance converter 23 and the output terminal of the inverting amplifier 24. R1, R2, R3 and R4 are substantially voltage dividing resistances. A contact between R1 and R2 is connected to the second contact of the switch, a contact between R2 and R3 is connected to the third contact of the switch, and a contact between R3 and R4 is connected to the fourth contact of the switch, respectively. Although the voltage dividing resistances R1, R2, R3, R4 may have any values, the same resistance value is set for all of them here. A moving contact of the switch is connected to the input terminal of the buffer amplifier 25. An output signal of the buffer amplifier 25 is output as a cold-side signal of the balanced output.

Assuming that the switch selects the first contact 1 as shown in FIG. 5, an output from the impedance converter 23 is input directly to the buffer amplifier 25. Thus, the noninverting output signal of microphone element 20 is output from the buffer amplifier 25 at a maximum level. The signal output from the buffer amplifier 25 is output as a cold-side signal of the balanced output. A directional characteristic of the signal balanced-output from OUT+ and OUT− as an output of the microphone unit is, therefore, bidirectional directivity as represented in reference symbol (i) in FIG. 3. If the switch selects the second contact 2, the noninverting output signal of the microphone element 20 is divided in voltage by the voltage dividing resistance, and the divided signal is input to the buffer amplifier 25. From the buffer amplifier 25, the noninverting output signal of the microphone element 20 is output at a middle level. The signal output from the buffer amplifier 25 is output as a cold-side signal of the balanced output. Directivity of the signal balanced-output from the OUT+ and OUT− as an output of the microphone unit is, thus, hypercardioid directivity as represented in reference symbol (ii) in FIG. 3.

If the switch selects the third contact 3, since a midpoint of voltage dividing resistances R1, R2, R3 and R4, that is the contact between resistances R2 and R3 is selected, an inverting output and a noninverting output of the inverting amplifier 24 both vanish. A directional characteristic of the signal balanced output from the OUT+ and OUT− as an output from the microphone unit is, thus, cardioid, i.e. unidirectionality as represented in reference symbol (iii) in FIG. 3. If the switch selects the fourth contact 4, the inverting output signal of the inverting amplifier 24 is divided in voltage by the voltage dividing resistance and the divided signal is input to the buffer amplifier 25. The signal output is output as a cold-side signal of the balanced output. A directional characteristic of the signal balanced-output from the OUT+ and OUT− as an output of the microphone unit is, thus, wide-cardioid directivity as represented in reference symbol (iv) in FIG. 3. If the switch selects the fifth contact 5, the inverting output level of the inverting amplifier 24 is directly input to the buffer amplifier 25. The signal output is output as a cold-side signal of the balanced output. A directional characteristic of the signal balanced-output from the OUT+ and OUT− as an output of the microphone unit is, thus, nondirectionality as represented in reference symbol (v) in FIG. 3.

The conventional variable directional condenser microphone unit illustrated in FIG. 4 is not designed for an electret condenser unit and therefore cannot be applied to an electret condenser microphone unit. DC voltage about 60V necessary for polarization voltage and a bipolar DC voltage source are required. In an assumption that a battery-operated microphone uses a battery, however, even when multiple batteries are used in series, the voltage at several volts falls short of polarization voltage. Then the DC voltage is multiplied by incorporating a DC-DC converter. The DC-DC converter includes an oscillator having an oscillatory frequency of, for example, 1 MHz and this leads to a disadvantage that an oscillatory signal generated by the oscillator becomes a source of noise for the audio signal. Disadvantageously, the voltage dividing resistance becomes a load on the DC-DC converter and the battery is exhausted more rapidly when the performance of the DC-DC converter is improved.

In the conventional variable directional condenser microphone unit, the inverting amplifier is connected to one output signal of a pair of the microphone elements and the voltage dividing resistance is connected to an output circuit of the inverting amplifier. This requires a current to flow into the voltage dividing resistance, and the current becomes a load on the inverting amplifier. In other words, the load needs to be driven by the inverting amplifier. In order to reduce the load on the inverting amplifier, the value of the voltage dividing resistance may be increased. The voltage dividing resistance that is increased in value causes noise to deteriorate the SN ratio of the audio signal.

An object of the present invention is to solve the above-explained problems in the conventional technique, that is, to provide a variable directional condenser microphone unit and a variable directional condenser microphone that switch directivity by switching an electrical circuit, in which the circuit for switching the directivity does not become a load or cause noise.

### SUMMARY OF THE INVENTION

According to an aspect of the present invention, a variable directional condenser microphone unit includes a pair of microphone elements disposed back to back, output signal systems of the microphone elements connected to a hot-side terminal and a cold-side terminal of balanced output respectively, an inverting amplifier connected to one output signal system of the microphone elements, at least one of an input resistance or a feedback resistance of the inverting amplifier is divided, a switching device switching a signal retrieving point by arbitrarily selecting each divide of at least one of the input resistance or the feedback resistance, in which the switching device switches one output of the balanced output to enable directivity of the balanced output signal to vary.

The switch switches a level and a polarity of an output signal in the other output signal systems of the balanced output, and thereby varies the directivity of the balanced output signal. Since the directivity is varied by selecting the divide of the input resistance or the feedback resistance, a circuit for switching the directivity does not become a load or a noise source.

### BRIEF DESCRIPTION OF THE DRAWINGS

FIG. 1 is a circuit diagram illustrating an embodiment of a variable directional microphone unit according to the present invention;

FIG. 2 is a circuit diagram illustrating another embodiment of a variable directional microphone unit according to the present invention;

FIG. 3 is a pattern diagram illustrating an embodiment of various directivities switchable by the variable directional microphone;

FIG. 4 is a circuit diagram illustrating a conventional variable directional microphone unit; and

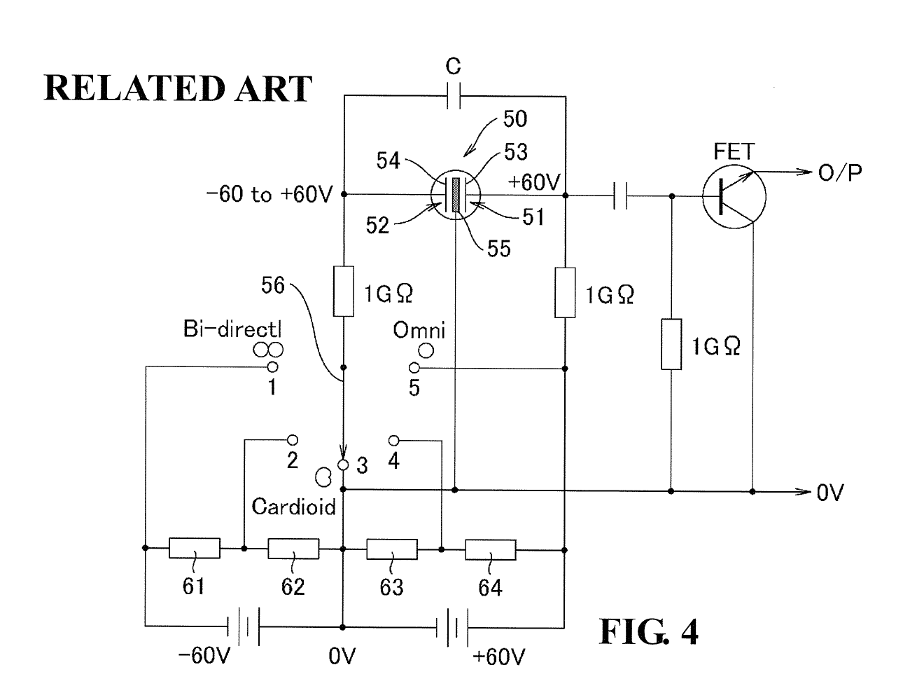

FIG. 5 is a circuit diagram illustrating another conventional variable directional microphone unit.

### DESCRIPTION OF THE PREFERRED EMBODIMENTS

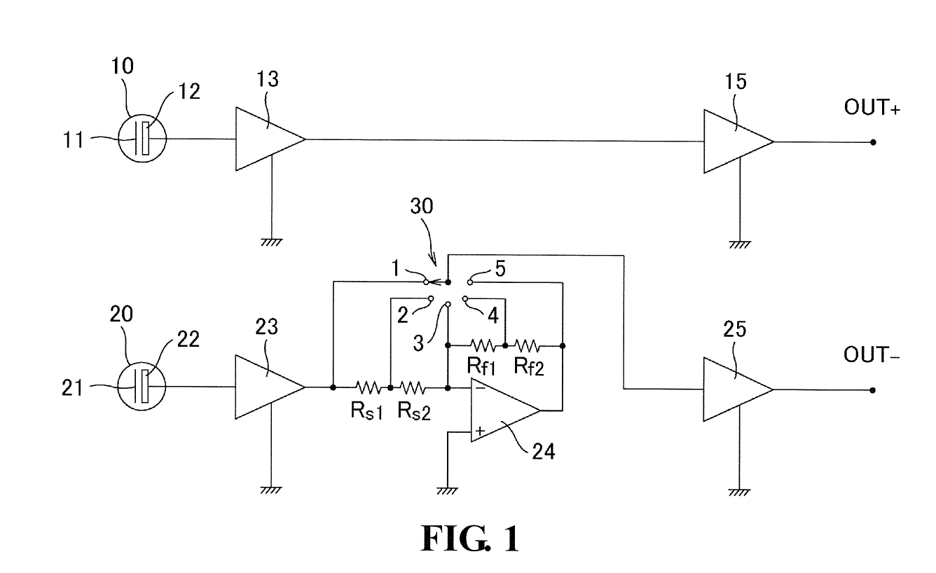

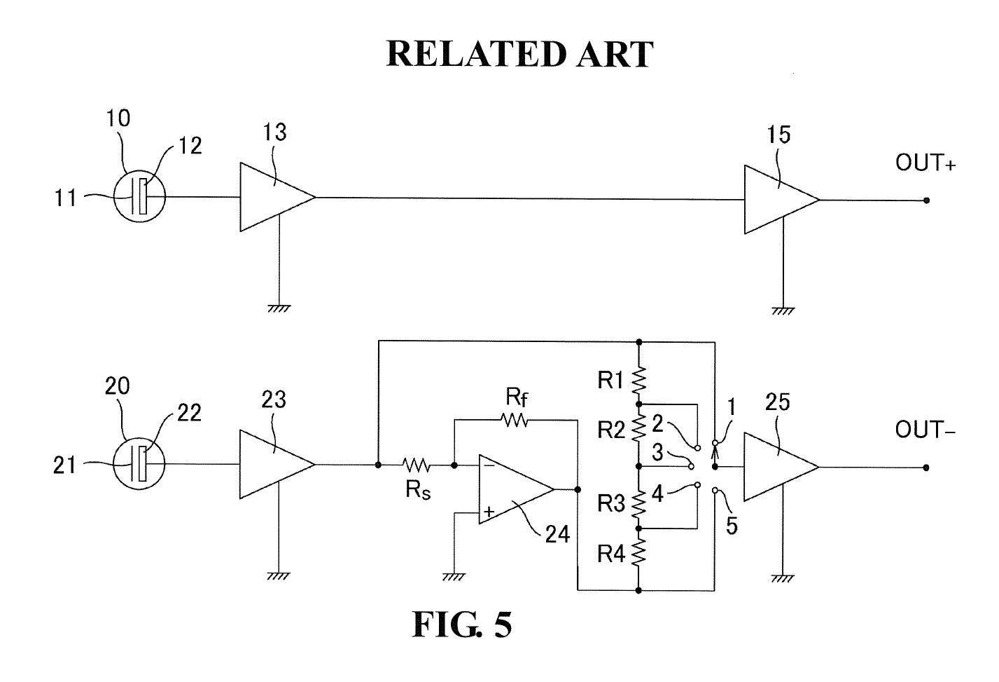

Embodiments of a variable directional microphone unit and a variable directional microphone according to the present invention are explained below with reference to FIGS. 1 to 3. Components similar to those in a conventional example shown in FIG. 5 are assigned with identical reference numerals.

### First Embodiment

FIG. 1 illustrates condenser microphone elements 10 and 20. The microphone element 10 includes a diaphragm 11 and a fixed electrode 12 facing the diaphragm 11. A signal output from the microphone element 10 is output as a hot-side signal “OUT+” of balanced output through an impedance converter 13 including an FET and a buffer amplifier 15. Also the microphone element 20 includes a diaphragm 21 and a fixed electrode 22 facing the diaphragm 21. A signal output from the microphone element 20 is output as a hot-side signal “OUT−” of balanced output through an impedance converter 23 including an FET and a buffer amplifier 25. For example, the two condenser microphone elements 10 and 20, which are individually assembled, are integrally assembled by disposing the fixed electrodes 12 and 22 back to back, or anteroposteriorly integrally assembled by having a common fixed electrode. Accordingly, the pair of the microphone elements 10 and 20 are disposed back to back.

The microphone element 10 is a front element while the microphone element 20 is a rear element. The following directivity switching circuit including the inverting amplifier 24 is incorporated between the impedance converter 23 and the buffer amplifier 25 of the microphone element 20. The output signal of the impedance converter 23 is input to an inverting input terminal of the inverting amplifier 24 through input resistances including two input resistances Rs1 and Rs2 that are connected in series. A non-inverting input terminal of the inverting amplifier 24 is grounded. Feedback resistances are connected between an output terminal of the inverting amplifier 24 and the non-inverting input terminal. The feedback resistances include two feedback resistances Rf1 and Rf2 that are connected in series. A gain of the inverting amplifier 24 is determined by a rate between the feedback resistances and the input resistances. As described above, the input resistances are divided as Rs1 and Rs2, while the feedback resistances are divided as Rf1 and Rf2. A switch 30 switches between a divide and a non-divide for these resistances to vary directivity of the balanced output signal by switching one output of the balanced output signal. Since the two input resistances Rs1 and Rs2 are equal in value to the two feedback resistances Rf1 and Rf2, any different value may be set according to a design concept.

The switch 30 includes a moving contact and five switching contacts (fixed contacts). The moving contact is connected to an input terminal of the buffer amplifier 25. A first switching contact 1 in the switch 30 is connected to an output terminal of the impedance converter 23. A second switching contact 2 in the switch 30 is connected to a node of the input resistances Rs1 and Rs2. A third switching contact 3 in the switch 30 is connected to the inverting input terminal of the inverting amplifier 24. A fourth switching contact 4 in the switch 30 is connected to a node of the feedback resistances Rf1 and Rf2. A fifth switching contact 5 in the switch 30 is connected to a node of the output terminal of the inverting amplifier 24.

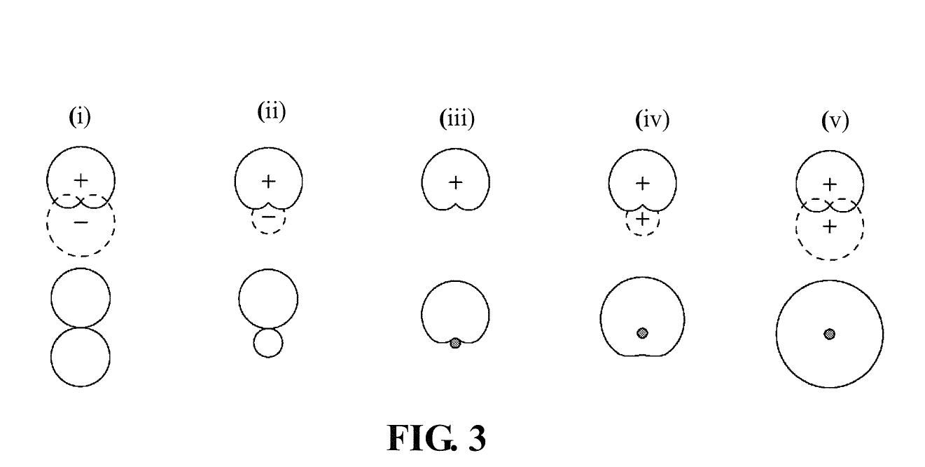

Operations for the embodiment as configured above are explained below. In FIG. 1, when the switch 30 selects the contact 1, an output of the impedance converter 23 is directly input to the buffer amplifier 25. An output of the rear microphone element 20, thus, is directly input from the impedance converter 23 to the buffer amplifier 25 without passing though the inverting amplifier 24, and output as a cold-side signal of the balanced output. The cold-side signal is equal in polarity and directivity to the hot-side signal and has negative polarity at a destination of the balanced output indicated by a broken line of reference symbol (i) in FIG. 3. Accordingly, at the destination of the balanced output, a cardioid directional characteristic output from the one microphone element 10 (hot side) is combined with a cardioid directional characteristic of reversed polarity from the other microphone element 20 (cold side) to be a bidirectional output.

When the switch 30 selects the contact 2, the node between the input resistances Rs1 and Rs2 of the inverting amplifier 24, that is, the divide of the input resistances is selected to retrieve the signal therefrom. The signal is output as a cold side signal of the balanced output through the buffer amplifier 25. The cold side signal of the balanced output is a positive-polar signal that has low-level cardioid directivity by broken line of reference symbol (ii) in FIG. 3. At the destination of the balanced output, the cold-side signal is inverted into a negative-polar signal. Accordingly, at the destination of the balanced output, a cardioid directional characteristic output from the one microphone element 10 (hot side) is combined with the cold-side signal to obtain a hypercardioid directional characteristic.

When the switch 30 selects the contact 3, the inverting input terminal of the inverting amplifier 24 is selected so that the signal level input to the buffer amplifier 25 is zero. As a result of this, only the cold-side signal of the balanced output which has the cardioid directional characteristic output from the microphone element 10 is balanced output.

When the switch 30 selects the contact 4, the node of feedback resistances Rf1 and Rf2 of inverting amplifier 2, that is, the divide of the feedback resistances is selected to retrieve the signal therefrom. The signal is output as a cold side signal of the balanced output through the buffer amplifier 25. The cold side signal of the balanced output is a negative-polar signal that has low-level cardioid directivity indicated by the broken line of reference symbol (vi) in FIG. 3. At the destination of the balanced output, the cold-side signal is inverted into a positive-polar signal. Accordingly, at the destination of the balanced output, a cardioid directional characteristic output from the one microphone element 10 (hot side) is combined with the cold-side signal to obtain a wide-cardioid directional characteristic.

When the switch 30 selects the contact 5, an output signal from the output terminal of the inverting amplifier 24 is directly input to the buffer amplifier 25. A gain of the inverting amplifier 24 is determined by a value obtained by combining the input resistances Rs1 and Rs2 and a value obtained by combining the feedback resistances Rf1 and Rf2. The cold side signal of the balanced output is a full-level and negative-polar signal that has low-level cardioid directivity indicated by the broken line of reference symbol (v) in FIG. 3. At the destination of the balanced output, the cold-side signal is inverted into a positive-polar signal. Accordingly, at the destination of the balanced output, a balanced output of the hot side having a cardioid directional characteristic output from the one microphone element 10 is combined with the cold-side signal to obtain a nondirectional characteristic.

According to the embodiment in FIG. 1, directivity of the balanced output signal systems can be varied by providing the inverting amplifier 24 dividing the input resistances from the feedback resistances and a switch 30 arbitrarily selecting the divide of input resistances and the feedback resistances of the inverting amplifier 24 to switch the signal retrieving point. Since the input resistances and feedback resistances are not loads on the inverting amplifier 24, consumption of electricity can be controlled. Since the switch between the input resistances and the feedback resistances does not vary the value of the input resistances and the feedback resistances of the inverting amplifier 24, a gain of the inverting amplifier 24 does not vary. Furthermore, since the input resistances and the feedback resistances do not need to have a high resistance, noise generated from the resistance can be reduced. Since directivity is not switched by switching polarizing voltage of the condenser microphone, this invention can be applied to electret condenser microphones. Since a direct power supply voltage does not need to be multiplied, a DC-DC converter needs not to be built in. The switch 30 corresponds to a switching device in the claims.

In the embodiment depicted in FIG. 1, both of the input resistances and the feedback resistances of the inverting amplifier 24 are divided and one divide is selected from all divides of the input resistances by the switch 30 for switching to be able to vary directivity. Only the input resistances, however, may be divided and one divide may be selected from the multiple divides of the input resistances. Furthermore, only the feedback resistances may be divided and one divide may be selected from the multiple divides of the input resistances. Since in the case where only the input resistances or the feedback resistances are divided and one divide is selected, the range of switching directivity is limited. For the purpose of extending the range of switching directivity, it is preferable to divide both of the input resistances and the feedback resistances and select one divide from the multiple divides.

### Second Embodiment

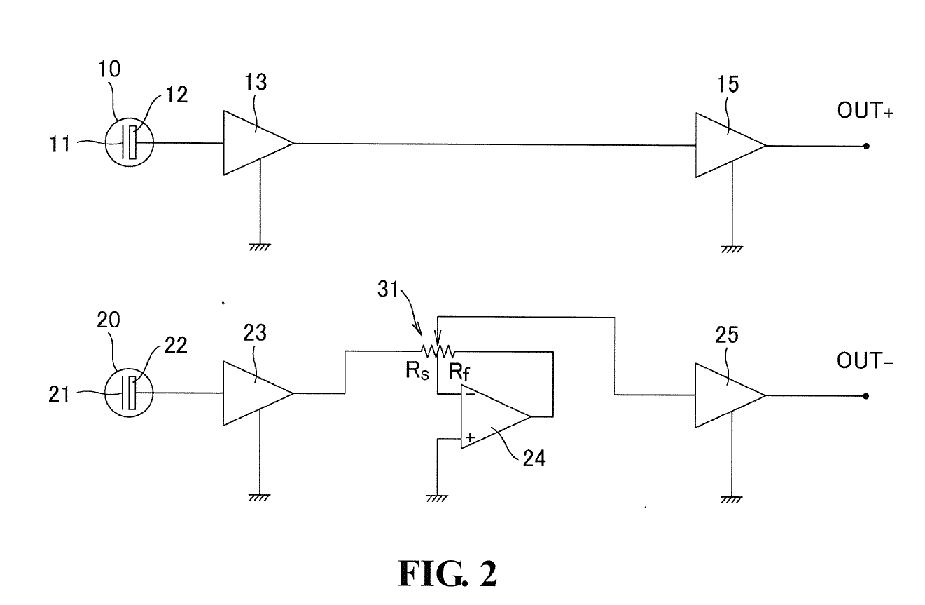

A second embodiment is depicted in FIG. 2. The second embodiment differs from the first embodiment in using a center-tapped variable resistance as a device for switching directivity. A center tap of the variable resistance 31 is connected to the inverting input terminal of the inverting amplifier 24. In the variable resistance 31, one side at a remove from the center tap is an input resistance Rs and the other side at a remove from the center tap is a feedback resistance Rf of the inverting amplifier 24. A slider of the variable resistance 31 is connected to the input terminal of the buffer amplifier 25. A signal generated in the slider is output to one side of balanced output, that is, as a cold-side signal shown in the example of FIG. 2. The variable resistance 31 may be optionally controlled by a user or a semi-fixed resistance that semi-fixedly keeps an adjusted position after adjusting directivity. Since the other components are similar to those of the first embodiment, explanation thereof is omitted.

As illustrated in FIG. 2, the slider of the center-tapped variable resistance 31 is placed in the same position as the center tap. This substantially means that the switch 30 selects contact point 3 in the embodiment shown in FIG. 1, and therefore, a directional characteristic of the balanced output signal is a cardioid directivity as represented in (iii) of FIG. 3.

Sliding the slider of the variable resistance 31 toward the input resistance Rs is substantially the same as continuously dividing the input resistances Rs. Furthermore, when the slider moves in the vicinity of the center of the input resistances Rs, the switch 31 selects contact point 2 in the embodiment of FIG. 1, and retrieves a signal by selecting this divide, thereby outputting the signal as a cold-side signal of the balanced output through the buffer amplifier 25. The cold-side signal of the balanced output is a positive-polar signal having low-level cardioid directivity as represented by the broken line in (ii) of FIG. 3. At the destination of the balanced output, the polarity of the cold-side signal is inverted into a negative-polar signal. Accordingly, at the destination of the balanced output, a cardioid directional characteristic output from the one microphone element 10 (hot side) is combined with the cold-side signal to obtain a hypercardioid directional characteristic.

When the slider reaches the beginning of the input resistances Rs, directivity of the balanced output signal becomes bidirectional as represented in (i) of FIG. 3. Since the input resistance Rs and the feedback resistance Rf of the inverting amplifier 24 does not vary, the gain of the inverting amplifier 24 stays constant.

Sliding the slider of the variable resistance 31 from the central tap to the feedback resistances Rf side is the same as selecting the divide of the feedback resistance of the inverting amplifier 24 to retrieve a signal. The signal is output as a cold-side signal of the balanced output through the buffer amplifier 25. The cold-side signal of the balanced output is a negative-polar signal having low-level cardioid directivity as represented by the broken line in (iv) of FIG. 3. At the destination of the balanced output, the polarity of the cold-side signal is inverted into a positive-polar signal. Accordingly, at the destination of the balanced output, a cardioid directional characteristic output from the one microphone element 10 (hot side) is combined with cold-side signal to obtain a wide-cardioid directional characteristic.

When the slider reaches the end of the input resistances Rs, directivity of the balanced output signal becomes nondirectional as represented in (v) of FIG. 3.

The variable directional microphone unit according to the embodiment depicted in FIG. 2 shows a similar effect to that according to the embodiment depicted in FIG. 1. The central-tapped variable resistance 31 is applied to a device for switching directivity. Accordingly, a variable directional microphone unit having a simple structure can continually and steplessly switch the directivity.

The variable directional microphone unit according to the above-explained present invention can be configured by incorporating the variable directional microphone unit and a microphone connector for a balanced output in a microphone casing.

The variable directional microphone unit according to the present invention realizes indoor use such as in a studio as well as outdoor use, and further, directivity can be adjusted in accordance with the place of use, the purpose of use or other various conditions so as to have the best directivity.

What is claimed is:

1. A variable directional microphone unit comprising:
a pair of microphone elements disposed back to back;
output signal systems of the microphone elements connected to a hot-side terminal and a cold-side terminal of a balanced output respectively;
an inverting amplifier connected to one of the output signal systems of the microphone elements;
at least one of an input resistance and a feedback resistance of the inverting amplifier is divided; and
a switching device switching a signal retrieving point by arbitrarily selecting each divide of at least one of the input resistance or the feedback resistance, wherein
the switching device switches one output of the balanced output to enable directivity of the balanced output signal to vary

2. The variable directional microphone unit according to claim 1, wherein
the input resistance of the inverting amplifier is divided, and
the switching device arbitrarily selects a divide of the input resistance.

3. The variable directional microphone unit according to claim 1, wherein
the feedback resistance of the inverting amplifier is divided , and
the switching device arbitrarily selects a divide of the feedback resistance.

4. The variable directional microphone unit according to claim 1, wherein
the switching device switches the output from the one of the microphone elements to be directly output without being passed though the inverting amplifier.

5. The variable directional microphone unit according to claim 1, wherein
the switching device switches the output from the one of the microphone elements to be input to the inverting amplifier and to be output from the inverting amplifier at full-level.

6. The variable directional microphone unit according to claim 1, wherein
the switching device comprises a center-tapped variable resistance,
one side at a remove from the center tap of the variable resistance is an input resistance of the inverting amplifier and the other side at a remove from the center tap is a feedback resistance of the inverting amplifier, and
a slider of the variable resistance is an output signal at one side of the balanced output.

7. The variable directional microphone unit according to claim 1, wherein
both of the hot-side terminal and the cold-side terminal of the balanced output are connected to an output terminal through a buffer amplifier.

8. The variable directional microphone unit according to claim 1, wherein
the pair of microphone elements are condenser microphone elements,
an impedance converter and the buffer amplifier are respectively connected to the output signal systems of the pair of microphone elements in this order, and
the inverting amplifier and the switching device are interposed between the impedance converter of one side of the output signal systems and the buffer amplifier.

9. A variable directional microphone comprising:
a microphone casing incorporating a microphone unit therein, wherein
the microphone unit is the variable directional microphone unit according to claim 1.
